(19) United States
(12) Patent Application Publication
(10) Pub. No.: US 2018/0027448 A1
(43) Pub. Date: Jan. 25, 2018

(54) Methods and Arrangements for Enabling Uplink Radio Access in Clustered Alarm Scenarios

(71) Applicant: Telefonaktiebolaget LM Ericsson (publ), Stockholm (SE)

(72) Inventors: Bengt Lindoff, Bjärred (SE); Shehzad Ali Ashraf, Aachen (DE); Robert Baldemair, Solna (SE); Fredrik Lindqvist, Järfälla (SE)

(21) Appl. No.: 15/546,981

(22) PCT Filed: Jan. 30, 2015
(86) PCT No.: PCT/EP2015/051971

§ 371 Date: Jul. 27, 2017

(51) Int. Cl. H04W 28/04; H04W 72/04; H04L 12/24; H04W 72/14

(52) U.S. Cl. CPC H04W 28/044; H04W 72/14; H04W 72/0413; H04L 41/06; H04W 72/121

(57) ABSTRACT

The present disclosure relates to methods and devices in clustered alarm scenarios. More particularly the disclosure pertains to for enabling uplink radio access in clustered alarm scenarios. In particular, the disclosure relates to a method, performed in a radio network node, wherein the radio network node is configured for wireless communication with a plurality of electronic devices, of enabling uplink radio access. The method comprises determining S1 groupings, the groupings dividing the electronic devices into one or more groups and receiving S2, from one of the electronic devices, a request for radio resources. The method further comprises taking S3, in response to the request, measures to provide radio resources to the electronic device, as well as to provide radio resources to at least one of the other electronic devices belonging to the same group as the requesting electronic device and transmitting S4, to each electronic device for which measures are taken, a message comprising information related to the measures taken for that electronic device.

### TECHNICAL FIELD

The present disclosure relates to methods and devices in clustered alarm scenarios. More particularly the disclosure pertains to methods and arrangements for enabling uplink radio access in clustered alarm scenarios.

### BACKGROUND

The 3rd Generation Partnership Project, 3GPP, is responsible for the standardization of the Universal Mobile Telecommunication System, UMTS, and Long Term Evolution, LTE. The 3GPP work on LTE is also referred to as Evolved Universal Terrestrial Access Network, E-UTRAN. LTE is a technology for realizing high-speed packet-based communication that can reach high data rates both in the downlink and in the uplink, and is thought of as a next generation mobile communication system relative to UMTS. In order to support high data rates, LTE allows for a system bandwidth of 20 MHz, or up to 100 MHz when carrier aggregation is employed. LTE is also able to operate in different frequency bands and can operate in at least Frequency Division Duplex, FDD and Time Division Duplex, TDD, modes.

In 5G, i.e. 5th generation mobile networks, there will be evolvement of the current LTE system to 5G. The main task for 5G is to improve throughput and capacity compared to LTE. This is achieved by increasing the sample rate and bandwidth per carrier. 5G is also focusing on the use of higher carrier frequencies i.e. above 5-10 GHz.

One main object of a 5G radio concept is to support highly reliable ultra-low delay Machine-Type Communication, MTC, i.e., Critical-MTC. The Critical-MTC concept should address the design trade-offs regarding e.g., end-to-end latency, transmission reliability, system capacity and deployment, and provide solutions for how to design a wireless network for different industrial-application use cases. The Critical MTC system should in particular allow for radio resource management that allows the coexistence between different classes of applications: sporadic data, e.g., alert messages, periodic data, and others with e.g. real-time data (or simply best-effort data).

One approach is to mix C-MTC applications with ordinary Mobile Broadband, MBB, traffic on the newly defined 5G carrier. Hence, similar random access procedures as well as scheduling request procedures may be used for C-MTC applications as for MBB service, however with much tighter latency requirements/response times and/or reliability requirements.

Alert messages e.g., alarms is probably one important type of messages that needs support for critical MTC application. Alarms are typically rare events. Hence, the alarm may be of Random Access type in some cases while in other cases, where we can assume that electronic device has reasonable sync to the network node, a scheduling request may be used.

In many automation scenarios it might be likely that alarms come in clusters. That means, once a sensor is transmitting an alarm it is likely that other sensors may transmit alarms almost at the same time or very short time after the first alarm. A simple example of such type of alarm is the temperature/smoke alarm that could simultaneously trigger several closely spaced sensors. The alarms or alerts may come in the order of milliseconds, and the the network might not be able to detect the alarm message(s) with possible fatal problem/failure as a potential cause.

In any case, the system needs to be designed such that rare alarm events may be transmitted with very low latency and detected with high reliability.

One simple prior art solution for avoiding such risk for collisions is to allocate separate frequency/time resources for random access/scheduling request to all sensors sufficiently often in order to fulfill the latency requirements. However with that approach significantly amount of resources need to be pre-allocated that typically would not be used and hence very low system capacity is achieved.

However, it is desirable being able to handle clustered alarm situations in a good way such that high reliability detection for sporadic low latency traffic is provided without influencing capacity for other traffic.

### SUMMARY

An object of the present disclosure is to provide a radio network node which seeks to mitigate, alleviate, or eliminate one or more of the above-identified deficiencies in the art and disadvantages singly or in any combination.

This object is obtained by a method, performed in a radio network node, wherein the radio network node is configured for wireless communication with a plurality of electronic devices, of enabling uplink radio access. The method comprises determining groupings, the groupings dividing the electronic devices into one or more groups and receiving, from one of the electronic devices, a request for radio resources. The method further comprises taking, in response to the request, measures to provide radio resources to the electronic device, as well as to provide radio resources to at least one of the other electronic devices belonging to the same group as the requesting electronic device and transmitting, to each electronic device for which measures are taken, a message comprising information related to the measures taken for that electronic device.

The proposed method solves the collision risk problem, by being pro-active in taking measures to provide uplink, UL, resources, in advance, to electronic devices potentially giving an alarm in a near future of an alarm transmitted from an associated sensor. Thereby, good trade-off between system capacity and reliability in the communication between the C-MTC devices and Network node is achieved.

According to some aspects, the receiving comprises receiving a request for uplink resources, wherein the measures comprises allocating uplink resources to at least one of the other electronic device belonging to the same group as the requesting electronic device and then the transmitting comprises transmitting to each electronic device to which resources are allocated, a message that informs the electronic device about the uplink resources that are allocated to that electronic device.

This solves the collision risk problem, by allocating uplink resources to electronic devices based on the fact that they belong to the same group as another electronic device that has recently requested resources.

According to some aspects, the measures comprise allocating uplink resources to the requesting electronic device. Hence, if it is likely that an electronic device will soon request uplink resources, such resources will be allocated before a request is received.

According to some aspects, the measures comprise changing at least one access criterion for at least one of the other electronic device belonging to the same group as the requesting electronic device. By changing an access criterion, the risk of collision may be lowered for electronic devices that are likely to soon trigger an alarm.

According to some aspects, the determining is based on a likelihood of the electronic devices to be triggered by one or several events within a predefined time period. Thereby, risk of missing alarms that probably will appear, is minimized.

According to some aspects, the determining is further based on geographical location, because electronic devices in vicinity may be likely to trigger an alarm in the same time period.

According to some aspects, the determining comprises assigning each electronic device within the group a relative priority in relation to the other electronic device in the group.

According to some aspects, the determining further comprises including electronic devices served by another radio network node in the groups. Thus, resources may be allocated to electronic devices in other cells as well. According to some aspects, the transmitting comprises sending the message via another radio network node.

According to some aspects, at least one of the electronic devices comprises a sensor device. According to some aspects, the determining is further based on the type of sensor.

According to some aspects, the transmitting comprises transmitting a broadcast or multicast message. Hence, resources may be assigned to several electronic devices in parallel.

According to some aspects, the disclosure relates to a computer program comprising computer program code which, when executed, causes a radio network node to execute the methods described above and below.

According to some aspects, the disclosure relates to a network node, in a communication system, the network node being configured for detecting several messages of a preconfigured message type. The network node comprises a radio communication interface, a network communication interface configured for communication with other network nodes, and processing circuitry. The processing circuitry is configured to cause the network node to determine groupings, the groupings dividing the electronic devices into one or more groups; to receive, from one of the electronic devices, a request for radio resources; to take measures, in response to the request, to provide radio resources to the electronic device, as well as to provide radio resources to at least one of the other electronic devices belonging to the same group as the requesting electronic device and to transmit, to each electronic device for which measures are taken, a message comprising information related to the measures taken for that electronic device.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1a is illustrating embodiments of one network, where the proposed methods may be implemented;

FIG. 1b illustrates a collision scenario;

FIG. 2 is a flowchart illustrating embodiments of method steps in a network node;

FIG. 3 is an example node configuration of a network node, according to some of the example embodiments;

FIG. 4 is a signaling diagram illustrating an exchange of signals in an embodiment of a network; and

FIG. 5 is block diagrams illustrating embodiments of another network, where the proposed methods may be implemented;

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

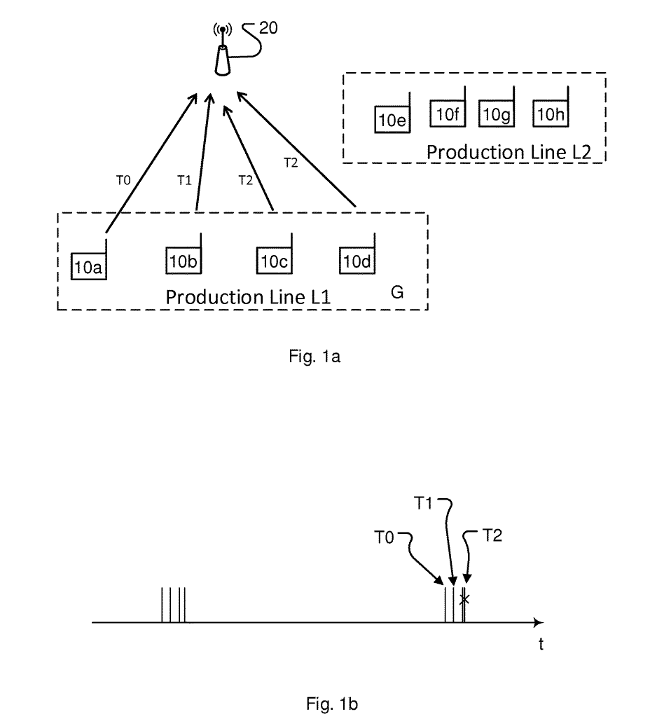

FIG. 1a is illustrating embodiments of a network, where the proposed methods may be implemented. In this example, four electronic devices 10a-10d, here being sensors, monitor a first production line, L1. Each sensor is connected to or integrated with a modem that may communicate with an access point or base station. Hence, from a radio perspective the sensor devices are referred to as user equipments, UE, which is the term used by 3GPP standardization.

This is an example scenario. During a long time, e.g. min/hours/days, no alarms are reported. Suddenly at time T0 sensor 10a detects a problem, and sends an alarm e.g. including a scheduling request. The network node 20, which is e.g. an eNodeB, then needs to allocate uplink resources in order for the sensor to report the exact alarm message. However, due to cascading failures and/or problems in the production line, an adjacent sensor 10b triggers an alarm at time T1, and a third and a fourth sensor 10c, 10d at time T2. All the sensors need allocated uplink resources for reporting the exact error messages. But all these errors may come in the order of milliseconds, and as in the example above alarms from 10c and 10d collide and the network node might not be able to detect the alarm message(s) with possible fatal problem and/or failure as a potential cause. The collision is illustrated in FIG. 1b.

The basic concept of the disclosure is that the scheduler in the network node 20, typically in the eNodeB, determines, e.g. by reading from an external source, associated sensors and stores that information. The scheduler is the function in a base station allocating radio resources to multiple users of e.g. a Long Term Evolution, LTE, cellular communication system. Hence, in LTE the eNodeB is in control of the radio spectrum and decides who is allowed to transmit when and on what frequency resources. When a UE wants to transmit a request e.g. a random access message or scheduling request, is sent to the eNodeB. The eNodeB allocates resources and then sends a message to the UE informing about which resources (time/frequency) to used. The message is called an uplink grant.

Associated sensors are sensors, which are likely to give alarms at approximately the same time. The determination may be done manually or may be done at connection setup via for instance UE capability information exchange. Then once the scheduler/Network node detects an alarm message, e.g. a random access or scheduling request associated with an alarm, from a first sensor in the group, the scheduler allocates uplink grants to associated sensors in the group and transmits the information to the associated sensors. Alternatively, the network node does not allocate the resources to the other devices, but facilitates the access to the uplink in another way, e.g. by changing some access criteria for the other electronic devices in the same group, such that collisions are avoided.

In the description below we discuss alarm or alert messages and scheduler action made once an alarm is detected in the network node. The alarm or alert message may be a message transmitted rather seldom and hence it may in some embodiments use random access channels and in other embodiments scheduling requests. However, the disclosure is not limited to these kinds of channels, but covers other channels with similar irregular occurrence, and where similar alert messages may be transmitted from associated sensors/modems etc. in a short time frame after a first sensor triggered an alert message.

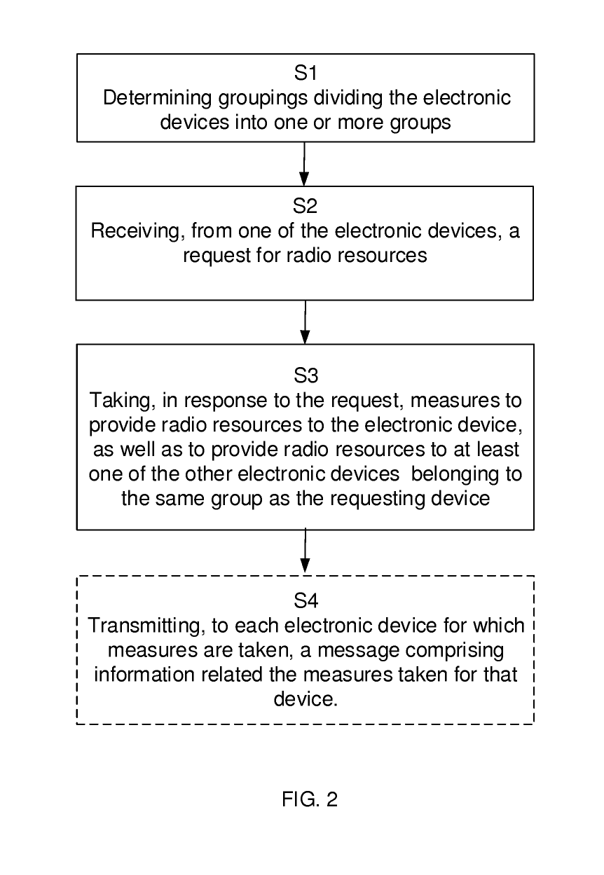

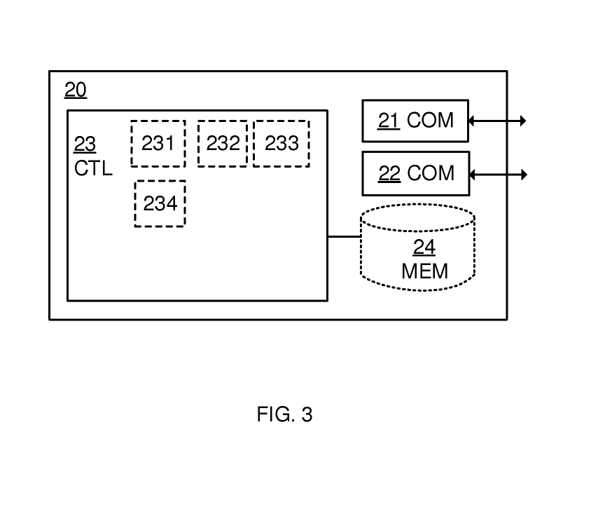

The proposed technique will now be described referring to FIG. 2 illustrating example node operations in a network node and FIG. 3 illustrating an example node configuration for performing these node operations.

It should be appreciated that FIGS. 2 and 3 comprise some operations and modules which are illustrated with a solid border and some operations which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations need not be performed in order.

FIG. 3 illustrates an example network node, configured for detecting several messages of a preconfigured message type. The network node is typically a radio network node or base station, such as an eNodeB in LTE. The network node 20 comprises radio communication interface 21, a network communication interface 22 and processing circuitry 23.

The radio communication interface 21 is configured for communication with wireless devices within reach of the network node over a wireless communication technology.

The network communication interface 22 is configured for communication with other network nodes. This communication is often wired e.g. using fiber. However, it may as well be wireless. The connection between network nodes is generally referred to as the backhaul.

The controller, CTL, or processing circuitry 23 may be constituted by any suitable Central Processing Unit, CPU, microcontroller, Digital Signal Processor, DSP, etc. capable of executing computer program code. The computer program may be stored in a memory, MEM 24. The memory 24 can be any combination of a Read And write Memory, RAM, and a Read Only Memory, ROM. The memory 24 may also comprise persistent storage, which, for example, can be any single one or combination of magnetic memory, optical memory, or solid state memory or even remotely mounted memory.

According to some aspects, the disclosure relates to a computer program comprising computer program code which, when executed, causes a radio network node to execute the methods described above and below.

The processing circuitry 24 is configured to perform the proposed methods of detecting several messages of a preconfigured message type. Hence, the processing circuitry 24 is configured to determine groupings, the groupings dividing the electronic devices into one or more groups; to receive, from one of the electronic devices, a request for radio resources. The processing circuitry 24 is further configured to take measures, in response to the request, to provide radio resources to the electronic device, as well as to provide radio resources to at least one of the other electronic devices belonging to the same group as the requesting electronic device and to transmit, to each electronic device for which measures are taken, a message comprising information related to the measures taken for that electronic device.

The proposed methods performed in a network node 20 will now be described in more detail referring to FIG. 2. It should be appreciated that the example operations of FIG. 2 may be performed simultaneously for any number of radio network nodes in the wireless communications network.

In an initial step, the method comprises determining groupings, step S1, wherein the electronic devices are divided into one or more groups. According to some aspects the processing circuitry 23 comprises a grouper 231 configured for determining the groupings of the electronic devices. In other words, the scheduler in a network node associates connected/registered sensors, or electronic devices, in groups. The grouping can either be done by the radio network node or the radio network node just receives the grouping information. In one example, the network node 20 receives (e.g. on request) the grouping from some server or network node and just applies it. The corresponding criteria may be used for the grouping even when performed outside the network node. The grouping may be made once e.g. at system startup and then used for a longer time period, i.e. for many messages. The grouping may also be dynamically and/or periodically updated. The association made by clustering sensors with likelihood to transmit alert/alarm or similar messages at approximately the same time. Referring to FIG. 1, as an example, sensors 10a, 10b, 10c, 10d for production line L1 are associated to a first group and sensors 10e, 10f, 10g, 10h for production line L2 are associated to a second group.

There are different ways to group sensors. According to some aspects, the determining is based on a likelihood of the electronic devices to be triggered by one or several events within a predefined time period. Such likelihood may e.g. be based on statistical calculations or predictions made using information e.g. about previous alarms.

According to some aspects, at least one of the electronic devices comprises a sensor device, e.g. as in the examples above. According to some aspects, the determining is further based on the type of sensor. In other words, the groups are determined on the basis of the type/function of sensors, e.g. all sensors of the same type/function are allocated to the same group. For example, at setup, all temperature sensors are allocated to one group.

According to some aspects, the determining is further based on geographical location. Electronic devices in a vicinity of one another may be likely to trigger alarms within the same time period. Hence the grouping may be determined based on geographical location, or on a combination of type/function of sensor and geographical location. For example, two sensors of the same type that are closely spaced, say within a couple of meters, are grouped together.

The method further comprises receiving, step S2, from one of the electronic devices, a request for radio resources. According to some aspects the processing circuitry 23 comprises a receiver module 232 configured for receiving the request. In other words a detector in the network node monitors the uplink for alarm or alert messages. The receiving step S2 implies that one wireless device requests uplink resources from the network node 20. Hence, the wireless device needs uplink resources in order to e.g. provide more information about the alarm. As mentioned above, the received alarm may be transmitted on a random access channel or as a scheduling request on an uplink control channel.

The method further comprises taking measures, step S3, in response to the request, to provide radio resources to the electronic device, as well as to provide radio resources to at least one of the other electronic devices belonging to the same group as the requesting electronic device. Or stated differently, the risk of missing a request is reduced by either modifying the reception methods, such that collisions are avoided or by granting access to devices, even if no request is received. Thus, if a message is detected in step S2, the scheduler then performs e.g. a table lookup to find the group of sensors associated with the sensor transmitting the alarm/alert message, i.e. one of the groups defined/determined in step S1. The scheduler may take actions in order to avoid missing alarms or alerts from UEs in the same group in the near future. According to some aspects the processing circuitry 23 comprises a provider 233 configured for providing radio resources.

Hence, the proposed method solves the collision risk problem, by being pro-active in taking measures to provide uplink resources, in advance, to electronic devices potentially giving an alarm in a near future of an alarm transmitted from an associated sensor. There are different measures that may be taken as will further be defined below.

Finally, according to some aspects, the method comprises transmitting, step S4, to each electronic device for which measures are taken, a message comprising information related to the measures taken for that electronic device. According to some aspects the processing circuitry 23 comprises a transmitter module 234 configured for transmitting the response. The network node generally needs to inform the UE about the measures taken, e.g. by specifying uplink resources that a UE can use as will be further explained below. In other words the network node communicates information about the measures taken to concerned devices. If the radio device has an alternative interfaces, eNB could theoretically use that for informing about the measures, e.g. send an “email” via a fixed network.

According to some aspects, the receiving step S2 comprises receiving a request for uplink resources, wherein the measures comprise allocating uplink resources to at least one of the other electronic devices belonging to the same group as the requesting electronic device and then the transmitting comprises transmitting to each electronic device to which resources are allocated, a message that informs the electronic device about the uplink resources that are allocated to that electronic device. In other words, the measures taken by the scheduler may be to actually allocate resources to one or several other electronic devices in the group, irrespective of whether any request for resources is received from those particular devices. Radio resources refers to a defined part of the radio spectrum such as specific code, time or frequency resources that may be allocated for a specific purpose. In this case the purpose is typically for a particular electronic device to transmit to a base station, i.e. uplink resources. Resources may be allocated to all the electronic devices in the group or to a few selected or prioritized electronic devices. Hence, if it is likely that an electronic device will soon request uplink resources, such resources will be allocated before a request is received. Typically resources are also allocated to the requesting electronic device.

According to some aspects, the measures comprise changing at least one access criterion for at least one of the other electronic device belonging to the same group as the requesting electronic device. This may involve e.g. changing a detection threshold, adding processing capacity or hardware, or changing access resources or preamble used in order to avoid missing any future alarms.

According to some aspects, the determining comprises assigning each electronic device within the group a relative priority in relation to the other electronic device in the group. In other words, the associated sensors which have been clustered together might also be prioritized in terms of their criticality. For instance, the most critical sensor out of the associated sensors will be allotted the highest priority level. This embodiment may help in further reduction of failure probability of receiving scheduling request or alarms. A decentralized back-off method is developed so that the highest priority scheduling request is transmitted successfully without experiencing a collision. After reliably receiving the message, the scheduler schedules an UL grant to the associated sensors of only lower priorities. This embodiment may also help in reducing the capacity requirements since low priority associated sensors are only scheduled after receiving the scheduling request of the highest priority sensor. In another embodiment, after some time, if scheduling request of associated sensor of higher priority level is reliably received by the network node, then the scheduler may also perform an intelligent scheduling of UL grant based on the alarms it has already received from, or based on resources it has scheduled to, other lower priority sensors associated with it. In other words, the scheduler may also use the historical information in order to select sensors, to which resources should be assigned.

According to some aspects, the transmitting comprises transmitting a broadcast or multicast message. Such a message may be read by several electronic devices. Hence, resources may be assigned to several electronic devices in parallel. In some embodiments, uplink, UL, grants are sent to all or at least several sensors in the group, and upon reception of data (i.e. no alarm/error event (yet) or alarm/error event) respective sensors are allocated more UL grants or not. For example one transmit message is addressing the whole group, requiring all electronic devices to read a control channel(s) for such messages and thereby saving system resources.

In other embodiments, the sensors in the group may be allocated persistent scheduling grants for a first period of time, i.e. allocated time instants for the next forthcoming ms/s/minutes (dependent on application). The persistent scheduling may also be applied to the sensor transmitting the initial alarm.

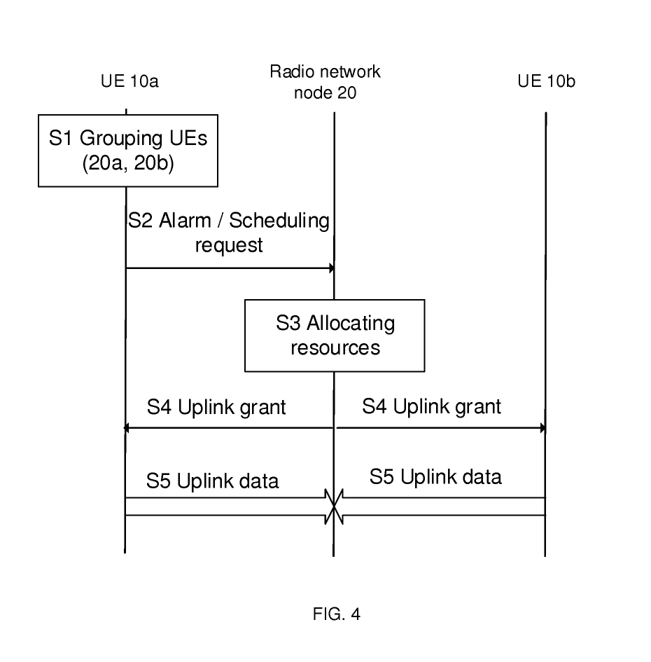

FIG. 4 is a signaling diagram illustrating an exchange of signals in an embodiment of a network; In this example sensors 10a and 10b are grouped S1 into one group. In FIG. 4 it is shown that an electronic device 10a triggers an alarm S2.

However, in response to the alarm the eNodeB 20 allocates S3 uplink resources to both sensor 10a and sensor 10b and informs S4 the sensors 10a, 10b about the resources by an uplink grant, such that both sensors can immediately send uplink data S5 comprising information about the alarm. Hence, sensor 10b will get resources, even though the request was not correctly received.

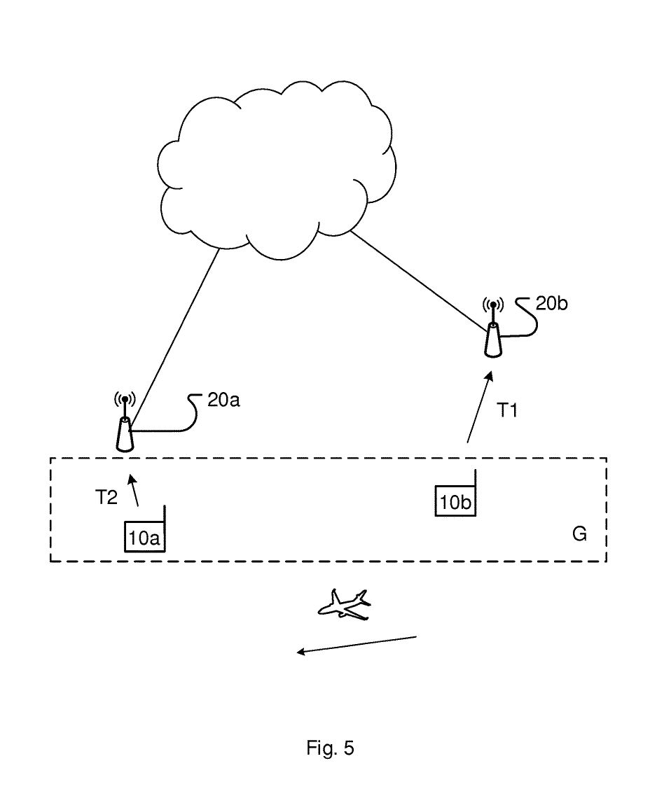

FIG. 5 illustrates another example scenario where the proposed methods may be implemented. In this example we have two sensors, 10a, 10b, e.g. radar sensors, seismic sensors or audio sensors positioned far from each other. In this example we have a fast moving object such as an aircraft. In this example we know that once the aircraft has passed sensor 10b, moving in a certain direction e.g. along a runway, then it will soon also pass sensor 10a. Sensors 10a and 10b are connected to separate cells or communication networks that may be connected e.g. via the internet.

Hence, according to some aspects, the determining further comprises including electronic devices served by another radio network node in the groups. Thus, resources may be allocated to electronic devices in other cells or networks as well. The cells or networks may use different Radio Access Technologies, RATs. This aspect typically implies that the transmitting of information related to the measures taken for an electronic device 10b comprises sending S4 the message via another cell, here e.g. another radio network node 20b. Hence, request for uplink resources by electronic device 10a served by one base station 20a may trigger that uplink resources are provided to an electronic device 20a served by another base station 20b.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that although terminology from 3GPP LTE has been used herein to explain the example embodiments, this should not be seen as limiting the scope of the example embodiments to only the aforementioned system. Other wireless systems, including WCDMA, WiMax, UMB, GSM, and Wi-Fi may also benefit from the example embodiments disclosed herein.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A cell is associated with a radio node, where a radio node or radio network node or eNodeB used interchangeably in the example embodiment description, comprises in a general sense any node transmitting radio signals used for measurements, e.g., eNodeB, macro/micro/pico base station, home eNodeB, access node/point, relay, discovery signal device, or repeater. A radio network node herein may comprise a radio network node operating in one or more frequencies or frequency bands. It may be a radio network node capable of CA. It may also be a single- or multi-RAT node. A multi-RAT node may comprise a node with co-located RATs or supporting multi-standard radio (MSR) or a mixed radio network node.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access

Memory (RAM), compact discs (CDs), digital versatile discs (DVD), etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1-21. (canceled)

22. A method of enabling uplink radio access, performed in a radio network node, the radio network node being configured for wireless communication with a plurality of electronic devices, the method comprising:
determining groupings, the groupings dividing the electronic devices into one or more groups;
receiving, from one of the electronic devices, a request for radio resources;
taking, in response to the request, measures to provide radio resources to the electronic device, as well as to provide radio resources to at least one of the other electronic devices belonging to the same group as the requesting electronic device; and
transmitting, to each electronic device for which measures are taken, a message comprising information related to the measures taken for that electronic device.

23. The method of claim 22, wherein the receiving comprises receiving a request for uplink resources, wherein the taking measures comprises allocating uplink resources to at least one of the other electronic device belonging to the same group as the requesting electronic device and wherein the transmitting comprises transmitting, to each electronic device to which resources are allocated, a message that informs the electronic device about the uplink resources that are allocated to that electronic device.

24. The method of claim 22, wherein the measures comprise allocating uplink resources to the requesting electronic device.

25. The method of claim 22, wherein the measures comprise changing at least one access criterion for at least one of the other electronic device belonging to the same group as the requesting electronic device.

26. The method of claim 22, wherein the electronic devices are configured to be triggered by one or several events under certain conditions, wherein reacting to these events involves a need for uplink radio resources.

27. The method of claim 26, wherein the determining is based on a likelihood of the electronic devices to be triggered by one or several events within a predefined time period.

28. The method of claim 22, wherein the determining is further based on geographical location.

29. The method of claim 22, wherein the determining comprises assigning each electronic device within the group a relative priority in relation to the other electronic device in the group.

30. The method of claim 22, wherein the determining further comprises including electronic devices served by another radio network node in the groups.

31. The method of claim 22, wherein at least one of the electronic devices comprises a sensor device.

32. The method of claim 30, wherein the determining is further based on the type of sensor.

33. The method of claim 22, wherein the transmitting comprises sending the message via another radio network node.

34. The method of claim 22, wherein the transmitting comprises transmitting a broadcast or multicast message.

35. The method of claim 22, wherein the event is an alarm or an alert.

36. The method of claim 22, wherein the request is a random access or a scheduling request.

37. The method of claim 22 wherein the message is an uplink grant.

38. The method of claim 37, wherein the uplink grant is a persistent scheduling grant.

39. The method of claim 37, wherein the uplink grant is valid for a time period.

40. The method of claim 37, wherein the uplink grant is a single scheduling grant.

41. A non-transitory computer-readable medium comprising, stored thereupon, a computer program comprising computer program code that, when executed, causes a radio network node configured for wireless communication with a plurality of electronic devices to:
determine groupings, the groupings dividing the electronic devices into one or more groups;
receive, from one of the electronic devices, a request for radio resources;
take, in response to the request, measures to provide radio resources to the electronic device, as well as to provide radio resources to at least one of the other electronic devices belonging to the same group as the requesting electronic device; and
transmit, to each electronic device for which measures are taken, a message comprising information related to the measures taken for that electronic device.

42. A network node, in a wireless communication system, the network node being configured for detecting several messages of a preconfigured message type, the network node comprising:
a radio communication interface circuit;
a network communication interface circuit configured for communication with other network nodes, and
processing circuitry configured to cause the network node:
to determine groupings, the groupings dividing the electronic devices into one or more groups;
to receive, from one of the electronic devices, a request for radio resources;
to take measures, in response to the request, to provide radio resources to the electronic device, as well as to provide radio resources to at least one of the other electronic devices belonging to the same group as the requesting electronic device; and
to transmit, to each electronic device for which measures are taken, a message comprising information related to the measures taken for that electronic device.
